(19) United States
(12) Patent Application Publication
(10) Pub. No.: US 2015/0114521 A1
(43) Pub. Date: Apr. 30, 2015

(54) Jig for Use with Router Table

(71) Applicant: Gerald Tower, San Mateo, FL (US)

(72) Inventor: Gerald Tower, San Mateo, FL (US)

(21) Appl. No.: 14/516,635

(22) Filed: Oct. 17, 2014

Related U.S. Application Data
(60) Provisional application No. 61/895,039, filed on Oct. 24, 2013.

(51) Int. Cl. B27C 5/06

(52) U.S. Cl. CPC B27C 5/06
USPC 144/371; 144/253.9

(57) ABSTRACT

A jig that allows a user to simultaneously cut two workpieces using a router table. The jig includes a first base positioned horizontally on a work surface that is pivotally attached to a second base positioned vertically on a work surface. The first and second base each include an adjustable clamp thereon that can be used to hold a workpiece in place on the router table. The first base further includes a handle thereon. A first workpiece can be positioned horizontally adjacent to the first base, and a second workpiece can be positioned vertically and flush against the second base. The user can move the jig and workpieces towards a router bit so that the workpieces come in contact therewith so as to cut both workpieces successively. In this way, the user can accurately cut two workpieces that fit together to form a right angle.

### CROSS REFERENCE TO RELATED APPLICATION

This application claims the benefit of U.S. Provisional Application No. 61/895,039 filed on Oct. 24, 2013, entitled “All Corners Perfect.” The above identified patent application is herein incorporated by reference in its entirety to provide continuity of disclosure.

### BACKGROUND OF THE INVENTION

1. Field of the Invention

The present invention relates to a woodworking tool that can be used to securely hold a first workpiece in a horizontal position and a second workpiece in a vertical position so that a woodworker can simultaneously cut the first and second workpieces using a router table in order to produce precise cuts. The woodworking tool includes vertical and horizontal base portions pivotally secured together by a hinge. A handle is disposed on the horizontal base portion for a user to hold, and each base portion comprises an adjustable clamp thereon for securing a workpiece in a desired position. By simultaneously cutting the workpieces, the user can efficiently and accurately shape the workpieces so that they can fit together to form a corner, or ninety degree angle.

Woodworkers must accurately and precisely cut and shape several pieces of wood so that the pieces can be assembled together to form a sturdy, functional, and aesthetically pleasing work product. In order to construct an object such as a piece of furniture from wood, the woodworker must cut and shape the pieces of wood so that they can fit together so as to form angles, particularly right angles. However, cutting pieces of wood so that the pieces fit together to form a right angle can be challenging even for experienced woodworkers. If the woodworker does not accurately shape or cut the pieces of wood, the woodworker must repeat the process until a workpiece has been shaped in the desired fashion. Repeatedly cutting pieces of wood can be time consuming for the woodworker. Further, the incorrectly cut pieces of wood may not be reusable for future projects, and are wasted as scrap.

Router tables are commonly used to cut a profile into the edge of a workpiece. A router table includes a flat, horizontal work surface having a pair of upstanding, vertical walls, or fences, extending therefrom. The pair of fences are arranged in a line and are separated by a gap. A router is positioned underneath the table such that the router bit extends above the surface of the table, and is positioned in the gap between the pair of fences. The router bit can have a variety of shapes and sizes in order to allow a user to cut various shapes or profiles into a workpiece.

In operation, the woodworker can position a workpiece, such as a piece of wood, horizontally on the table surface. The woodworker can then position the workpiece flush against the fence and move the workpiece therealong so that it contacts the router bit. The fences are used to guide the workpiece in order to control the cutting process. As the workpiece passes over the router bit, the bit etches a profile or pattern into the workpiece. The woodworker can alternatively position the workpiece vertically so that it is flush against a fence and feed the workpiece towards the bit in the same fashion.

Holding the pieces of wood by hand may result in an imprecise cut if the woodworker is unable to firmly hold the piece of wood. Further, holding the workpieces by hand may create the risk of the woodworker's hand contacting the router bit, which could result in serious injury to the woodworker. Additionally, cutting workpieces one by one can be time consuming, particularly where the woodworker must shape a multitude of workpieces in order to construct a particular work product.

Thus, the present invention provides a jig for use with a router table comprising a first base disposed vertically and attached by a hinge to a second base that is disposed horizontally. A support is used to hold the first and second bases at a desired angle relative to one another. The first and second base each comprise an adjustable clamp thereon for holding a workpiece against the first and second base, respectively. A handle is disposed on said first base in order to provide the user with a firm grip for holding and guiding the jig. A first workpiece can be positioned horizontally such that it is flush against the table surface and having a side thereof contacting the first base. A second workpiece can be positioned vertically, and flush against the second base. Once the workpieces are secured, the user can move the jig and the workpieces secured thereto along the fences on the router table and into the router bit. In this way, the user can use the jig of the present invention to simultaneously cut the first and second workpieces in order to produce a precise and accurate cut on both workpieces.

2. Description of the Prior Art

Devices have been disclosed in the prior art that relate to woodworking tools. These include devices that have been patented and published in patent application publications. These devices generally relate to router tables. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 4,884,604 to Rice et al. discloses a mitre gauge to be utilized with woodworking tools. The supporting surface of the mitre gauge is movable about horizontal and vertical axes to accommodate any desired angle of contact between the workpiece and cutting tool. The mitre gauge includes an elongated member that slides within a groove disposed on a supporting table, and a support plate that is coupled with the supporting member and movable about a vertical axis. The support plate serves as a vertical surface on which a guide can be mounted and that can be moved into different positions. A planar surface can be pivotally coupled with the support plate and can be disposed at various angles. Thus, Rice et al. discloses a mitre gauge that can be used to hold a workpiece at a variety of angles in relationship to a cutting tool. Rice et al. does not disclose a jig adapted to secure a pair of workpieces so that a user may simultaneously cut a first and second workpiece in one motion.

Another device, U.S. Pat. No. 6,138,372 to Newman discloses a guide apparatus for use with a router comprising a body adapted to receive a router base and having an opening for a router bit, a reference member having a planar surface, a hinge that connects the reference member to the main body. The reference member can be secured to the main body at a desired angle. A guide bar helps to direct the router bit of the router along the edge of the workpiece. Thus, Newman fails to disclose a device adapted to hold a first workpiece in a horizontal position, and a second workpiece in an upright or angled position so that the user may simultaneously cut both workpieces in a single motion.

U.S. Pat. No. 6,775,917 to Campbell discloses an adjustable jig for use with a table saw. The jig is adapted to hold a workpiece in a variety of angled positions so that the workpiece can be cut using the table saw. The device includes a pair of rotating arms connected by a cross brace, and at least one clamp thereon for securing a workpiece. The arms can be adjusted to a desired angle, and one or more angle guides are included for selecting a desired angle. Thus, Campbell fails to disclose a jig comprising a first base hingedly secured to a second base, wherein a first and second workpiece can be secured thereto via adjustable clamps. Campbell does not disclose a device that allows a user to simultaneously shape two workpieces.

U.S. Pat. No. 5,611,378 to Brazell discloses a router table comprising a tiltable table so that the user may position the router axis horizontally or perpendicularly with respect to the base. The tiltable table comprises a primary table pivotally secured to the base, a fence that can be secured perpendicularly to the primary table, a router mounting plate attached to the primary table and adapted to receive a router, and an adjustment mechanism for varying the position of the router mounting plate. Thus, Brazell fails to disclose a jig for holding workpieces and instead discloses a router table having a tiltable table assembly.

Finally, U.S. Pat. No. 5,396,937 to Clausen discloses a router table on which a handheld, portable router can be secured. The router table includes an angularly adjustable and movable table top pivotally connected to a stationary table top. Thus, Clausen discloses a router table on which a portable router can be positioned and that includes a tiltable table surface. Clausen fails to disclose a jig for supporting one or more workpieces such that a user may cut both workpieces in a single motion.

These prior art devices have several known drawbacks. Several devices in the prior art disclose router table devices having adjustable surfaces for cutting a workpiece at an angle. Such devices do not provide a means for simultaneously cutting a pair of workpieces held in different configurations, and are instead adapted to cut a single workpiece at a time. Further, such devices require users to replace their existing router table, which may be an expensive and inconvenient solution for users wishing to cut workpieces at angles. Other devices include adjustable jigs used to hold a workpiece at a desired angle for cutting. While such devices are adapted to be used with conventional router tables, such devices do not allow a user to simultaneously cut a pair of workpieces in a single motion. Thus, a user must cut workpieces one by one, which is time consuming and may result in imprecise cuts that do not allow the workpieces to be fitted together so as to form a right angle.

In light of the devices disclosed in the prior art, it is submitted that the present invention substantially diverges in design elements from the prior art and consequently it is clear that there is a need in the art for an improvement to existing jig devices for use with router tables. In this regard the instant invention substantially fulfills these needs.

### SUMMARY OF THE INVENTION

In view of the foregoing disadvantages inherent in the known types of jigs and workpiece holding devices now present in the prior art, the present invention provides a new jig device wherein the same can be utilized for providing convenience for the user when cutting workpieces such that they can be fitted together to form an angle.

It is therefore an object of the present invention to provide a new and improved jig device for use with a router table that has all of the advantages of the prior art and none of the disadvantages.

It is another object of the present invention to provide a jig for use with a router table that allows a user to simultaneously cut two workpieces.

Another object of the present invention is to provide a jig for use with a router table that allows a user to simultaneously cut two workpieces such that the workpieces can be fitted together to form a corner or a right angle.

Yet another object of the present invention is to provide a jig for use with a router table comprising adjustable clamps used to secure workpieces thereto.

Still another object of the present invention is to provide a jig for use with a router table comprising an upright base that allows a user to position a workpiece at a variety of angles.

Another object of the present invention is to provide a jig for use with a router table that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the woodworking tool of the present invention.

FIG. 2 shows a close-up view of the adjustable clamp of the present invention.

FIG. 3 shows a side view of the woodworking tool of the present invention.

FIG. 4 shows a perspective view of the woodworking tool of the present invention in use on a router table.

FIG. 5 shows a planar view of a corner formed from two pieces of wood shaped using a router table.

### DETAILED DESCRIPTION OF THE INVENTION

Reference is made herein to the attached drawings. Like reference numerals are used throughout the drawings to depict like or similar elements of the jig of the present invention. For the purposes of presenting a brief and clear description of the present invention, the preferred embodiment will be discussed as used for simultaneously cutting two workpieces such that the workpieces can be fitted together so as to form a ninety degree angle. The figures are intended for representative purposes only and should not be considered to be limiting in any respect.

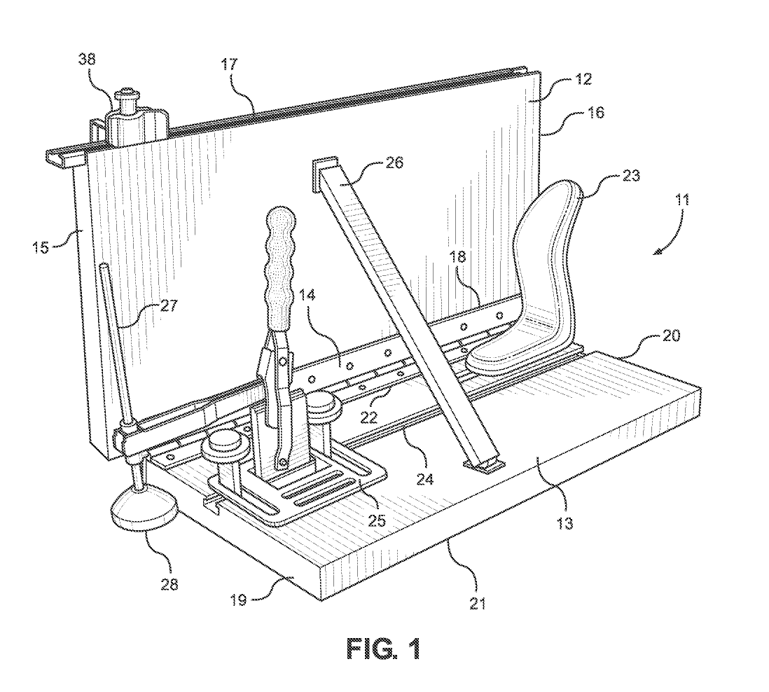

FIG. 1 shows a perspective view of the woodworking tool of the present invention. The jig 11 of the present invention comprises a first base 13 that is substantially rectangular and that is pivotally secured to a second base 12 by a hinge 14. The first base 13 includes a first end 19 opposite a second end 20, and a first side 21 opposite a second side 22, defining the perimeter of the first base 13. Similarly, the second base 12 includes a first end 15 opposite a second end 16, and a first side 17 opposite a second side 18. The hinge 14 is pivotally connects the second side 22 of the first base 13 and the second side 18 of the second base 12. The first base 13 is adapted to be disposed horizontally on a surface, such as on a work table. The second base 12 is positioned vertically, or the second base 12 can be positioned at an angle relative to the first base 13.

A support arm 26 extends between the first base 13 and second base 12 so as to hold the second base 12 at a desired angle relative to the first base 13. Preferably, the support arm 26 is used to maintain the first base 13 in a position orthogonal to the second base 12. The support arm 26 comprises an elongated rod that may be adjustable in length so as to allow the second base 12 to be held at an angle relative to the first base 13. The support arm 26 may be telescopic in order to extend or retract. The support arm 26 is preferably disposed roughly centrally on said first base 13 and said second base 12 so as to support the second base 12 in a stable, upright orientation.

A handle 23 is disposed on the first base 13 and extends upward therefrom. The handle 23 comprises an elongated member having a flange on the upper end thereof. Preferably, the handle 23 is located near the second end 20 of the first base 13. In operation, the user can hold the handle 23 in order to move the jig 11 of the present invention on a work surface. The handle 23 allows the user to accurately guide the jig 11 while cutting one or more workpieces secured thereto. The handle 23 can be composed of rubber in order to provide a high-friction surface that can be easily grasped, however, other suitable materials may be used.

The first base 13 further comprises an elongated channel 24 extending from the first end 19 to the second end 20 thereof. The elongated channel 24 is preferably parallel to the first and second sides 21, 22 of the first base 13. An adjustable clamp 25 can be secured to the elongated channel 24 and can be positioned in any location along the length thereof as desired by the user. The adjustable clamp 25 includes an elongated bar 27 having a foot 28 thereon. The foot 28 is adapted to contact the upper surface of a workpiece, and to hold the workpiece flat against a work surface. Similarly, the second base 12 includes an adjustable clamp 38 thereon. The adjustable clamp 38 is preferably disposed on said first side 17 of said second base 12 and is adapted to hold a workpiece flush against said second base 12.

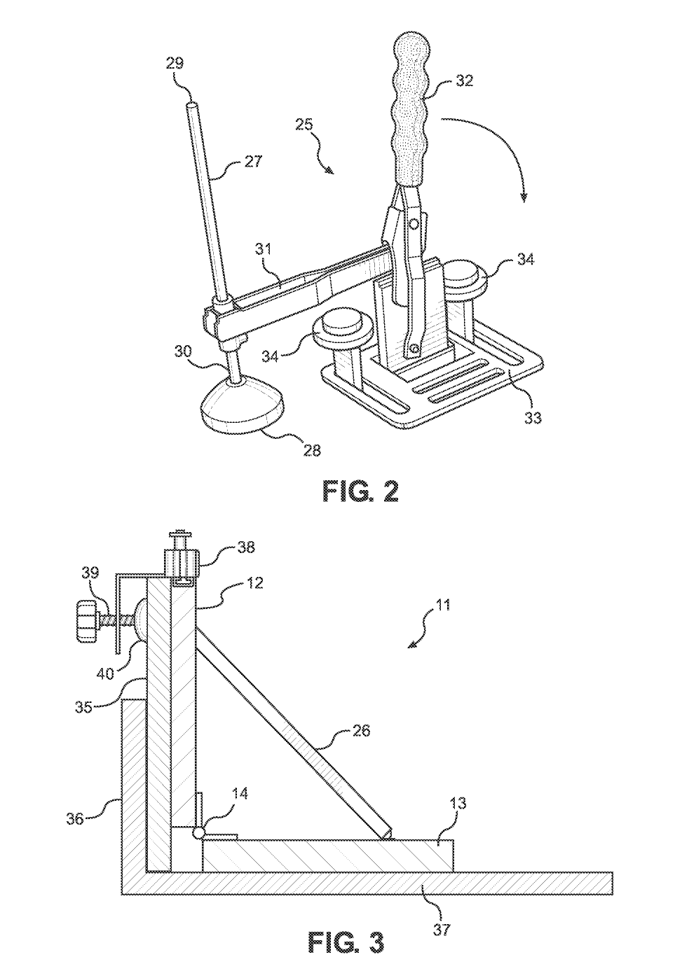

Referring now to FIG. 2, there is shown a close-up view of the adjustable clamp of the present invention. The adjustable clamp 25 comprises a plate 33 that is flat and substantially rectangular. The base 33 further comprises an upright section to which a handle 32 is pivotally secured. The handle 32 can be positioned in an upright orientation and can be rotated between a first and a second position. The handle 32 actuates a support arm 31 that is positioned horizontally and extends outward from the first base. An elongated bar 27 is disposed in a substantially vertical orientation on an end of the support arm 31 and includes a first end 29 and a second end 30 on which a foot 28 is disposed. The elongated bar 27 is oriented such that it is substantially perpendicular to the support arm 31. In this way, when the handle 32 is actuated, the support arm 31 lowers, along with the elongated bar 27, bringing the foot 28 into contact with the upper surface of a workpiece. The handle 32 can be locked into position so as to securely and firmly hold a workpiece in position on the work surface.

A pair of locking mechanisms 34 are disposed on opposing ends of the plate 33 and are used to affix the plate 33 to the elongated channel on the first base. The locking mechanisms 34 are substantially cylindrical and comprise a widened disk-like portion on the upper end thereof to facilitate grasping the locking mechanisms 34. The locking mechanisms 34 may comprise threading thereon so that the locking mechanisms can be turned or screwed so as to lock or unlock the plate 33 into position on the elongated channel. Thus, the locking mechanisms 34 allow for the adjustable clamp 25 to be easily secured to the first base.

Referring now to FIG. 3, there is shown a side view of the woodworking tool of the present invention. The jig 11 of the present invention is adapted to be positioned on a router table having a work surface 37 and one or more fences 36 extending vertically upward therefrom. The first base 13 of the jig 11 is positioned flat on the work surface 37, and the second base 12 is disposed vertically, and perpendicular to the work surface 37. As such, the support arm 26 is configured so that the second base 12 is orthogonal to the first base 13. The second base 12 is used to hold a workpiece 35 in a vertical orientation. The workpiece 35 is positioned flush against the second base 12 and also flush against a fence 36. The workpiece 35 is positioned such that the leading edge of the workpiece 35 does not extend beyond the second base 12. In this way, the workpiece 35 is sandwiched between the second base 12 and the fence 36.

Additionally, the workpiece 35 is secured to the second base 12 by means of a second adjustable clamp 38. The adjustable clamp 38 comprises an elongated bar 39 with a foot 40 thereon that is adapted to be positioned against the surface of the workpiece 35. The second adjustable clamp 38 includes an L-shaped brace having a first section and a second section, wherein the first section extends outward from the second base 12 and is orthogonal to a second section that extends downward therefrom. The second section comprises an aperture adapted to allow the elongated bar 39 to move freely therein, so as to bring the foot 40 into contact with a workpiece 35 positioned against the second base 12. Thus, the upper portion of the workpiece 35 is secured between the foot 40 and the second base 12.

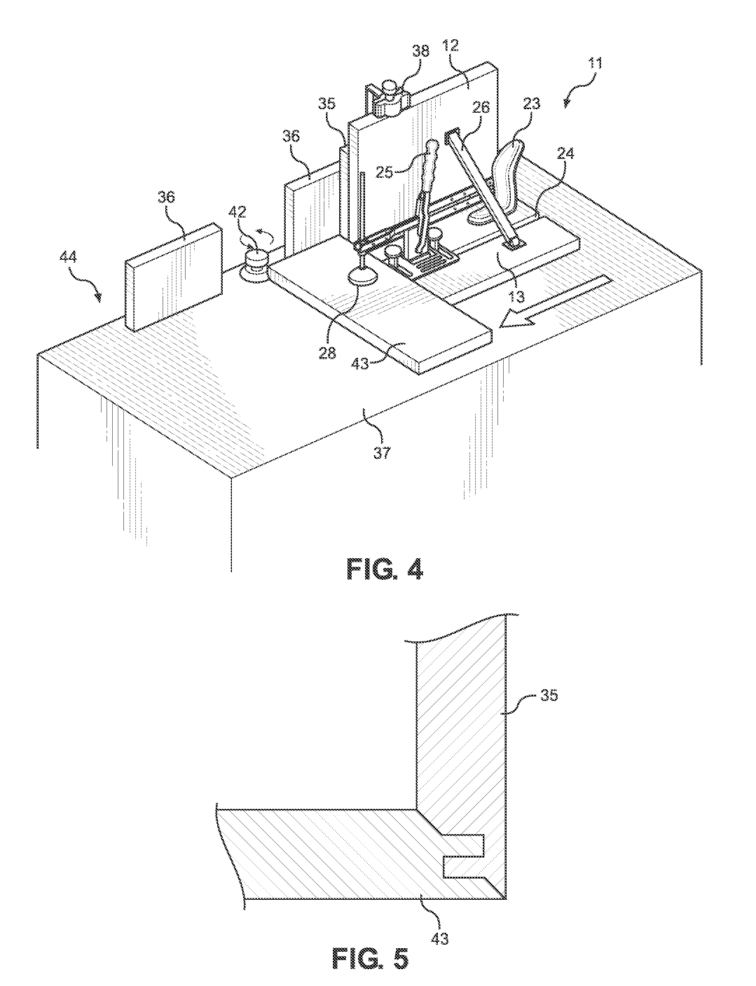

FIG. 4 shows a perspective view of the woodworking tool of the present invention in use on a router table. The router table 44 comprises a work surface 37 and one or more fences 36. The fences 36 extend vertically upward from the work surface 37 and are perpendicular thereto. The fences 36 are co-linear and are separated by a gap in which a router bit 42 is positioned. The router bit 42 is adapted to rotate at a high speed in order to cut and shape a portion of a workpiece. The fences 36 are used to guide the workpiece or workpieces towards the router bit 42.

The jig 11 of the present invention can be used to secure one or more workpieces thereto. A first workpiece 43 can be positioned flat against the work surface 37 such that an edge of the first workpiece 43 is positioned against the first end of the first base 13. The adjustable clamp can be moved along the channel 24 on the first base 13 so that the foot 28 on the second end of the elongated bar can hold the first workpiece 43 in position on the work surface 37. Additionally, a second workpiece 35 can be positioned vertically and flush against the second base 12. The second workpiece 35 is positioned so that the leading edge of the second workpiece 35 does not extend beyond the second base 12. Further, an adjustable clamp 38 on the second base 12 can be used to secure the second workpiece 35 thereto. Thus, the first workpiece 43 is positioned so as to first come into contact with the router bit 42. Once the first workpiece 43 has been cut, the second workpiece 35 will be cut in successive order. This allows a user to cut both workpieces 35, 43 in a single motion, by moving the jig 11 with the workpieces 35, 43 secured thereto towards the router bit 42.

Once the first and second workpieces 43, 35 are secured to the jig 11 in the desired orientation, the jig 11 can be moved towards the router bit 42. The user may hold the handle 23 in order guide the jig 11 and the workpieces 43, 35 thereon towards the router bit 42. After the first workpiece has been cut, the second workpiece 35 will be cut in successive order. This allows a user to cut both workpieces in a single motion.

FIG. 5 shows a planar view of a corner formed from two pieces of wood shaped using the jig of the present invention and a router table. The jig of the present invention is adapted to hold a first workpiece in a horizontal position and a second workpiece in a vertical position. The workpieces are then fed simultaneously into a router bit on a router table and the router bit cuts the workpieces such that they can be fitted to one another so as to form a corner, or a ninety degree angle. Thus, a first workpiece 43 can be disposed horizontally and brought into contact with a router bit adapted to carve a particular shape into the edge of the workpiece. A second workpiece 35 can be disposed vertically and brought into contact with the same router bit. In this way, a single router bit can be used to carve mating patterns into a first and second workpiece. The first and second workpieces can then be engaged with one another so as to create a right angle. Thus, a user can cut the first and second workpieces simultaneously using a single router bit such that the workpieces can be positioned together to form a corner.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A jig for use with a router table, comprising
a first base having a first end, a second end, a first side, and a second side, defining the perimeter of said first base;
a second base having a first end, a second end, a first side, and a second side, defining the perimeter of said second base;
wherein said second base is pivotally secured to said first base by a hinge secured to said second side of said first base and said second side of said second base;
an elongated channel on said first base and extending from said first end to said second end;
a first adjustable clamp positioned on said first base adapted to hold a first workpiece adjacent to said first base;
a second adjustable clamp positioned on said second base adapted to hold a second workpiece against said second base;
a handle disposed on said first base.

2. The jig for use with a router table of claim 1, wherein said first base is rectangular, and wherein said second base is rectangular.

3. The jig for use with a router table of claim 1, wherein said first adjustable clamp comprises a plate and one or more locking mechanisms;
wherein said one or more locking mechanisms are removably secured to said elongated channel.

4. The jig for use with a router table of claim 1, wherein said first adjustable clamp comprises a handle adapted to actuate a support arm on which an elongated bar having a foot is disposed, wherein said handle can be pivoted in order to engage said foot of said elongated bar with an upper surface of a workpiece positioned adjacent to said first end of said first base.

5. The jig for use with a router table of claim 1, further comprising:
a support arm extending between said first base and said second base;
wherein said support arm is adapted to hold said first base in an angled orientation with respect to said second base.

6. The jig for use with a router table of claim 5, wherein said support arm is adjustable in length.

7. The jig for use with a router table of claim 1, wherein said second adjustable clamp comprises an L-shaped brace and an elongated bar having a foot;
said L-shaped brace having a first section and a second section;
said section of said L-shaped brace having an aperture that is adapted to allow said elongated bar to move freely to adjust a distance between said foot and said second base.

8. A method of shaping workpieces, comprising the steps of:
utilizing a jig having a first base pivotally secured to a second base, wherein said first base comprises a handle thereon and a first adjustable clamp, and said second base comprises a second adjustable clamp;
securing a first workpiece positioned adjacent to said first base by engaging said first adjustable clamp with said first workpiece;
securing a second workpiece positioned adjacent to said second base by engaging said second adjustable clamp;
positioning said jig against a fence on a router table;
moving said jig along the length of said fence and towards a router bit disposed on said router table such that said router bit contacts and cuts said first workpiece and said second workpiece in successive order.
